(19) United States
(12) Patent Application Publication
(10) Pub. No.: US 2024/0051721 A1
(43) Pub. Date: Feb. 15, 2024

(54) CABLE TIE

(71) Applicant: Kyoung Ho PARK, Chungcheongnam-do (KR)

(72) Inventor: Kyoung Ho PARK, Chungcheongnam-do (KR)

(21) Appl. No.: 18/273,055

(22) PCT Filed: Jan. 18, 2022
(86) PCT No.: PCT/KR2022/000432

§ 371 Date: Jul. 19, 2023

(30) Foreign Application Priority Data
Jan. 19, 2021 (KR) 20-2021-0000183

(51) Int. Cl. B65D 63/18; B65D 63/10

(52) U.S. Cl. CPC B65D 63/18; B65D 63/1027; B65D 2563/108; B65D 2563/103

(57) ABSTRACT

A cable tie used to neatly arrange cables, includes: a fastening part having a locking protrusion formed along the longitudinal direction of one side surface; and a head part which is integrally formed at an end of the fastening part, has an insertion hole which penetrates the center of the front surface and through which the free end of the fastening part passes, and has a locking protrusion formed in a lower portion of the inside of the insertion hole so that the locking protrusion of the fastening part is fixed thereto. A screw fastening portion is formed in the fastening part.

### BACKGROUND

The present disclosure relates to a cable tie used for wire arrangement.

In general, a cable tie is widely used to neatly arrange wires connected inside household appliances, such as computers, televisions, refrigerators, and the likes, and cables like various communication lines, by bundling and fixing them in a bundle at an appropriate location.

A conventional cable tie, as illustrated in FIGS. 1 and 2, includes: a fastening part 2 which has locking protrusions 1 densely formed in a longitudinal direction of one side; and a head part 5 which is formed integrally at the end of the fastening part 2, and has an insertion hole 3 which penetrates the center of the front face and through which the free end of the fastening part 2 passes, and locking jaws 4 formed at a lower portion of the insertion hole 3 so that the locking protrusions 1 of the fastening part 2 are fixed thereto.

However, the conventional cable tie has no problem in neatly arranging the wires by bundling the wires W, cannot perfectly fix the wires W since it does not provide a role to hold the wires W not to move when the arranged wires W are moved by external force, such as the user's pulling or wind.

That is, the conventional cable tie can bundle the plurality of wires W into a single bundle, but cannot provide a role to prevent movement of the wires by fixing the wires W to a wall body. Accordingly, when the wires W are moved, since a terminal coupled to an end portion of the wire is also moved, a short circuit occurs, so it causes poor connection.

### SUMMARY OF THE INVENTION

Accordingly, the present invention has been made in view of the above-mentioned problems occurring in the related art, and it is an object of the present invention to provide a cable tie, which forms a screw fastening portion in the center of the cable tie for bundling a plurality of wires or tubes together, thereby allowing the bundled wires or tubes to be securely fixed to the wall.

It is another object of the present invention to provide a cable tie, which includes a plurality of screw-loosening prevention protrusions formed along the inner circumference of the screw fastening portion so that the plurality of screw-loosening prevention protrusions are rolled inwards between screw threads, thereby preventing the fastened screw from being separated even when fixed to a vibrating object.

To accomplish the above-mentioned objects, according to the present invention, there is provided a cable tie, which includes a fastening part having locking protrusions formed in a length direction of one side, and a head part integrally formed at one end of the fastening part, having an insertion hole formed through the center of a front side so that a free end of the fastening part pass through, and having a locking jaw formed at a lower portion inside the insertion hole such that the locking protrusion of the fastening part is fastened, including: a screw fastening portion formed in the fastening part.

The screw fastening portion is formed at a position closer to the head part than to the center of the fastening part.

The screw fastening portion comprises includes a flange having a screw fastening hole formed in the center, and screw loosening prevention protrusions, which protrude along the inner peripheral surface of the screw fastening hole.

The screw fastening portion is a flange having the screw fastening hole formed in the center.

The screw fastening portion is formed to have the same thickness as the fastening part or to be thicker than the fastening part.

The locking protrusions of the fastening part are formed from the front end to the end portion of the peripheral surface where the screw fastening portion is formed.

The screw fastening portion is formed to have a diameter larger than the width of the fastening part.

The cable tie according to an embodiment of the present invention has forms a screw fastening portion in the center of the cable tie for bundling a plurality of wires or tubes together, thereby allowing the bundled wires or tubes to be securely fixed to the wall. Furthermore, the cable tie according to an embodiment of the present invention includes a plurality of protrusions formed along the inner circumference of the screw fastening portion so that the plurality of protrusions are rolled inwards between screw threads when being screw-coupled, thereby preventing the fastened screw from being separated even when fixed to a vibrating object, and allowing the user to use the cable tie stably for a long time.

### BRIEF DESCRIPTION OF DRAWINGS

FIG. 1 is a perspective view of a conventional cable tie.

FIG. 2 is an exemplary view illustrating a state in wires are bundled using the conventional cable tie.

FIG. 3 is a perspective view of a cable tie according to a first embodiment of the present invention.

FIG. 4 is a perspective view of a cable tie according to a second embodiment of the present invention.

FIG. 5 is an exemplary view illustrating a state in which wires or tubes are bundled using the cable tie according to the present invention.

FIG. 6a is an exemplary view illustrating a state in which the cable tie according to the present invention is closely attached to a wall.

FIG. 6b is an exemplary view illustrating a state in which a screw is fastened to the cable tie according to the present invention.

FIG. 6c is an exemplary view illustrating a state in which wires or tubes are closely attached to the cable tie according to the present invention.

FIG. 6d is an exemplary view illustrating a state in which a fastening part is inserted into a head part so that the wires or tubes are bundled by the cable tie according to the present invention.

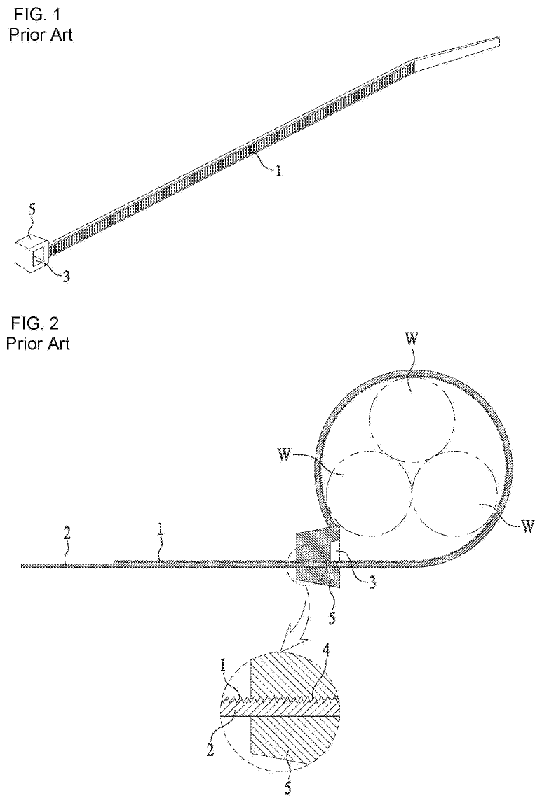

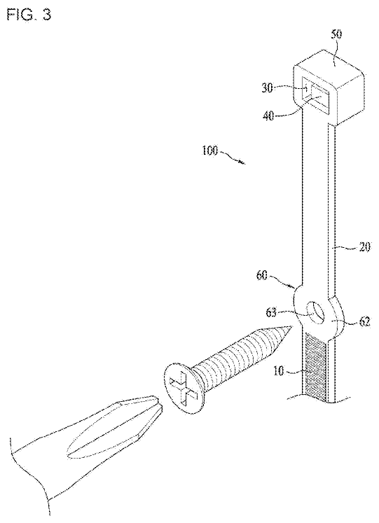

### DETAILED DESCRIPTION OF THE INVENTION

Hereinafter, exemplary embodiments of the present invention will be described with reference to the accompanying drawings. In the following description, the same elements will be designated by the same reference numerals although they are illustrated in different drawings. Further, in the following description of the present invention, a detailed description of known functions and configurations incorporated herein will be omitted when it may make the subject matter of the present invention rather unclear. In addition, a preferred embodiment of the present invention will be described hereinbelow, the technical thought of the present invention is not restricted or limited thereto and may be embodied in various manners through modification by those skilled in the art.

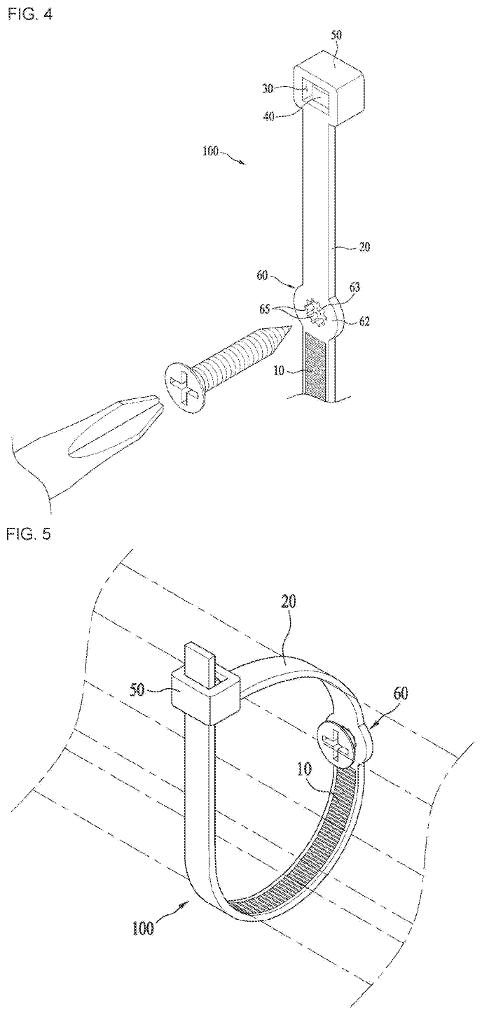

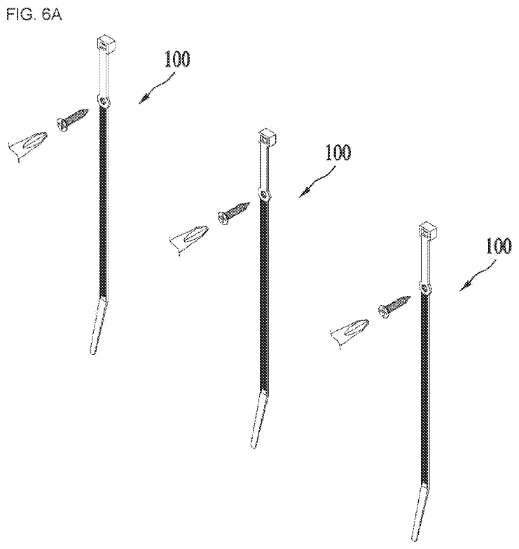

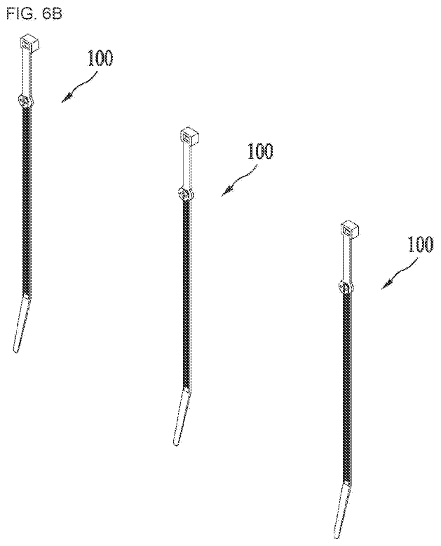

FIG. 3 is a perspective view of a cable tie according to a first embodiment of the present invention, FIG. 4 is a perspective view of a cable tie according to a second embodiment of the present invention, and FIG. 5 is an exemplary view illustrating a state in which wires or tubes are bundled using the cable tie according to the present invention.

As illustrated in FIG. 3 to FIG. 5, a cable tie 100 according to an embodiment of the present invention includes a fastening part 20, a head part 50 which is integrally formed at the front end of the fastening part 20, and a screw fastening portion 60 formed on the fastening part 20.

The fastening part 20 is formed by injection molding of synthetic resin, and is formed in a flat bar shape to maintain a predetermined width. A plurality of locking protrusions 10 are densely arranged on one surface of the fastening part 20. The locking protrusions 10 are arranged to maintain a predetermined slope together with ratchet protrusions.

Moreover, locking protrusions 10 of the fastening part are only formed between the front end and the screw fastening portion 60 which will be described later.

The head part 50 is formed integrally at an end portion of the fastening part 20. The head part 50 has an insertion hole 30 through which a free end of the fastening part 20 can pass. A locking jaw 40 is formed at a lower portion of the insertion hole 30 so that the locking protrusion 10 of the fastening part can be fastened.

Therefore, when the fastening part wraps the outer surface of the wire and the front end portion of the fastening part 20 is inserted into the insertion hole 30 of the head part, the locking jaw 40 formed at the lower portion of the insertion hole 30 is retained on the locking protrusion 10 formed on the outer surface of the fastening part 20, so that the fastening part 20 is fit and fixed only in one direction.

Meanwhile, a screw fastening portion 60 is formed on the fastening part 20. The screw fastening portion 60 is formed at a position closer to the head part 50 than to the center of the fastening part 20.

That is, the reason why the screw fastening portion 60 is not formed at the center of the fastening part 20 is that, in a case in which the bundled wire or tube has a small diameter, a clearance may occur because the head part 50 is not tightly fitted on the circumferential surface of the wire or tube even if a user hold the fastening part 20 and pull the wire as much as possible after the fastening part 20 is fitted into the head part 50.

The screw fastening portion 60 includes a flange 62 having a screw fastening hole 63 formed in the center, and screw loosening prevention protrusions 65, which protrude along the inner peripheral surface of the screw fastening hole 63.

The flange 62 has various outer shapes, such as a circular shape, a rectangular shape, or a polygonal shape. The flange 62 has the same thickness as the fastening part 20 or relatively thicker than the fastening part 20 to prevent damage during a screw fastening process.

In the center of the flange 62, the screw fastening hole 63 is formed through. The screw fastening hole 63 is designed to have diameters of various sizes according to the length and the width of the fastening part 20 and is perforated.

At this time, the screw fastening hole 63 can be perforated to have any shape, such as a circular shape, a rectangular shape, or a polygonal shape.

Furthermore, as illustrated in FIG. 4, a plurality of screw loosening prevention protrusions 65 may be formed to protrude on the inner peripheral surface of the screw fastening hole 63 as needed. The screw loosening prevention protrusions 65 may be formed to have a star shape as illustrated in the drawing.

That is, the screw loosening prevention protrusions 65 are configured to have the same or similar shape as loosening prevention washers sold in the market, and are formed to have a diameter smaller than the diameter of the screw threads being coupled, so that, the front ends of the screw loosening prevention protrusions 65 roll into between the screw threads during screw fastening.

Accordingly, if a screw needs to be installed in a location where vibration is present, the front ends of the screw loosening prevention protrusion 65 prevent the screw from loosening.

Furthermore, the diameter of the screw fastening portion 60 is larger than the width of the fastening part 20.

In other words, since the screw fastening hole 63 is formed in the center of the flange 62, the screw fastening portion 60 has a substantially narrow width between the inner and outer diameters of the flange 62 excluding the screw fastening hole 63.

In such a case, a portion of the flange 62 may tear due to friction with a portion of the screw during the screw fastening process.

Therefore, a distance between the inner and outer diameters of the flange 62 should secure a width that is at least twice as large as the width of the fastening part 20. Thus, when the fastening part 20 is viewed from the front, the diameter of the flange 62 is relatively larger than the width of the fastening part 20.

Hereinafter, the operation of the cable tie according to an embodiment of the present invention will be described in detail with reference to the attached drawings.

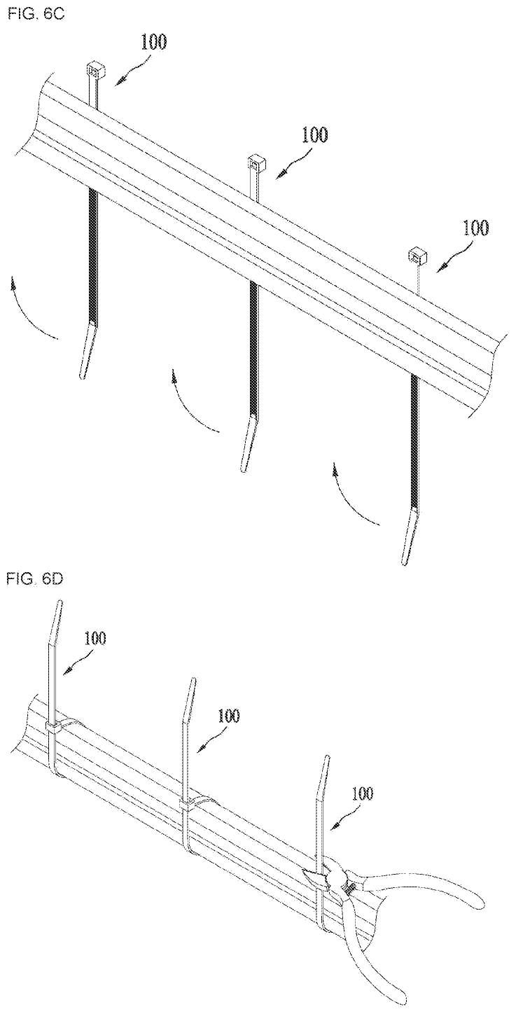

FIG. 6a is an exemplary view illustrating a state in which the cable tie according to the present invention is closely attached to a wall, FIG. 6b is an exemplary view illustrating a state in which a screw is fastened to the cable tie according to the present invention, FIG. 6c is an exemplary view illustrating a state in which wires or tubes are closely attached to the cable tie according to the present invention, and FIG. 6d is an exemplary view illustrating a state in which a fastening part is inserted into a head part so that the wires or tubes are bundled by the cable tie according to the present invention.

As illustrated in the drawings, in order to fix wires or tubes to a wall using the cable tie 100 of the present invention, the cable tie 100 comes into close contact with the wall surface, and then a front end of the cable tie is positioned at the center of the screw fastening portion 60.

When the screw is positioned, a power tool or a driver is fitted on the head of the screw, and then the screw is fastened to the wall surface, thereby fixing the cable tie 100 to the wall surface.

When the cable tie 100 is fixed to the wall surface, the wire or tube is closely adhered to the cable tie 100, and the front end of the fastening part 20 is fitted into the insertion hole 30 of the head part.

When the front end of the fastening part 20 is fitted into the insertion hole 30 of the head part, the user holds and pulls the front end of the fastening part 20 such that one side of the head part 50 is fixed to get in close contact with the surface of the wires or tubes.

Subsequently, the user cuts the front end of the fastening part 20 fitted into the head part 50 using scissors or a knife if necessary.

As described above, in a case in which wires or tubes are fixed on the wall surface by using the cable tie 100 according to an embodiment of the present invention, in a state that the cable ties 100 are arranged at regular intervals in advance, the cable ties are fixed by screw fastening, and the fixation is completed, wires or tubes come into contact with the surface of the cable tie 100. Thereafter, the wires or tubes can be quickly fixed while the fastening part 20 is fit to the head part 50. Therefore, the cable tie according to the present invention has significantly faster workability than saddle products (not shown) currently sold in the market.

The saddle products currently sold in the market are used for the purpose of fixing a wire or a tube to a wall or ceiling, but there is an inconvenience that the user has to fit the saddle product onto the wire or tube with one hand and tighten the screw with the other hand, because the saddle product cannot fix the wire or tube in a state of being fixed to the wall in advance.

However, with the cable tie 100 according to the present invention, the user can fix the cable ties at predetermined intervals by fastening screws at the predetermined intervals previously. Accordingly, the cable tie 100 according to the present invention is very convenient in terms of workability since the user only needs to press the wire or tube against the wall and simultaneously fit the fastening part 20 into the head part 50 with the other hand.

Therefore, the cable tie 100 according to an embodiment of the present invention can remove the inconvenience that the user has to tie two general cable ties currently on the market and fix the cable ties to the wall while fastening screws, and can compensate for the shortcomings of the saddle products, thereby providing considerable satisfaction to users.

As described above, while the present invention has been particularly shown and described with reference to the example embodiments thereof, it will be understood by those of ordinary skill in the art that the above embodiments of the present invention are all exemplified and various changes, modifications and equivalents may be made therein without changing the essential characteristics and scope of the present invention. Therefore, it would be understood that the embodiments disclosed in the present invention are not to limit the technical idea of the present invention but to describe the present invention, and the technical and protective scope of the present invention shall be defined by the illustrated embodiments. It should be also understood that the protective scope of the present invention is interpreted by the following claims and all technical ideas within the equivalent scope belong to the technical scope of the present invention.

1. A cable tie, which includes a fastening part having locking protrusions formed in a length direction of one side, and a head part integrally formed at one end of the fastening part, having an insertion hole formed through the center of a front side so that a free end of the fastening part pass through, and having a locking jaw formed at a lower portion inside the insertion hole such that the locking protrusion of the fastening part is fastened, comprising:
a screw fastening portion formed in the fastening part.

2. The cable tie according to claim 1, wherein the screw fastening portion is formed at a position closer to the head part than to the center of the fastening part.

3. The cable tie according to claim 1, wherein the screw fastening portion comprises includes a flange having a screw fastening hole formed in the center, and screw loosening prevention protrusions, which protrude along the inner peripheral surface of the screw fastening hole.

4. The cable tie according to claim 1, wherein the screw fastening portion is a flange having the screw fastening hole formed in the center.

5. The cable tie according to claim 1, wherein the screw fastening portion is formed to have the same thickness as the fastening part or to be thicker than the fastening part.

6. The cable tie according to claim 2, wherein the locking protrusions of the fastening part are formed from the front end to the end portion of the peripheral surface where the screw fastening portion is formed.

7. The cable tie according to claim 1, wherein the screw fastening portion is formed to have a diameter larger than the width of the fastening part.
